(19) United States
(12) Patent Application Publication
(10) Pub. No.: US 2008/0057960 A1
(43) Pub. Date: Mar. 6, 2008

(54) MOBILE COMMUNICATION DEVICE

(76) Inventors: Atte Lahtiranta, Mountain View, CA (US); Jari P. Hamalainen, Kangasala AS (FI); Ilpo Karjalainen, Oulu (FI); Heikki Heinaro, Helsinki (FI)

Correspondence Address: PERMAN & GREEN, 425 POST ROAD, FAIRFIELD, CT, 06824, US

(21) Appl. No.: 11/468,184

(22) Filed: Aug. 29, 2006

(51) Int. Cl. H04Q 7/20; H04M 1/00

(52) U.S. Cl. 455/435.2; 455/550.1; 455/556.1; 455/557

(57) ABSTRACT

A method including providing a link to at least one selectable communication service for communications to and from a device, wherein the link to the at least one selectable communication service is displayed in at least one area of a display of the device and enabling a user to select a communication service by activating the link associated with the communication service.

### CROSS-REFERENCE TO RELATED APPLICATIONS

This application is related to the following U.S. patent applications: “UNIFIED CONTACT DATABASE”, Attorney Docket Number 684-012586-US (PAR); “VOICE MAIL EXTENSION”, Attorney Docket Number 684-012587-US (PAR); “REPLYING THROUGH DIFFERENT CHANNELS”, Attorney Docket Number 684-012588-US (PAR); “ACTIVE IDLE EXTENSION”, Attorney Docket Number 684-012589; and “MOBILE COMMUNICATION DEVICE”, Attorney Docket Number 684-012590-US (PAR), all of which were filed on Aug. 29, 2006, the disclosures of which are incorporated herein by reference in their entirety.

### BACKGROUND

1. Field

The disclosed embodiments relate to communication devices and, more particularly, to communication devices with multi-channel communication.

2. Brief Description of Related Developments

Mobile terminals, or mobile (cellular) telephones, for mobile telecommunications systems like GSM, UMTS, D-AMPS, and CDMA2000 have been used for may years now. In the older days, mobile terminals were used almost exclusively for voice communication with other mobile terminals or stationary telephones. More recently, the use of modern terminals has been broadened to include not just voice communication, but also various other services and applications such as www/wap browsing, video telephony, electronic messaging (e.g. SMS, MMS, email, instant messaging), digital image or video recording, FM radio, music playback, exercise analysis, electronic games, calendar/organizer/time planner, word processing, etc. Furthermore, the modern terminals have local connectivity abilities, such as Bluetooth, allowing the mobile terminals to communicate with a wide array of devices.

With this great number of applications, user interaction naturally becomes complex and somewhat difficult. For example, in conventional terminals when a certain type of communication is received (e.g. a cellular communication, MMS, SMS, IM, etc.) a reply to that communication is made using the same communication protocol. For example, if user A initiates a cellular call that is received by a mobile phone of user B, user B either picks up the call or rejects the call. Where, for example user B is in a situation that user B cannot talk on the phone, user B may decline the call so that the call is sent into the user B's voice mail or user B may not answer the call without any explanation. User A may keep trying to call user B, creating a constant interruption to User B's activity (e.g. a meeting, in a movie theater).

To keep user A from interrupting user B's activities, user B may either answer the call, return the call to user A via another cellular communication, decline the call or turn the mobile phone off. User B may also respond to the call, after declining the call or at a later time, through a completely separate communication, such as an instant message that is unrelated to the received call. In conventional communication devices to send a separate communication, such as an instant message, in response to an incoming call a user must decline or reject the call or wait for the call to stop ringing and then search through the menus of the communication device to find the instant message function of the communication device. In conventional communication devices, if there is more than one service provider associated with instant messaging, the user has to find the appropriate screen or interface within the communication device that corresponds to the desired service provider as each service provider has its own dedicated user interface.

One attempt to simplify the use of mobile terminals is to use two dimensional menus, allowing the user to see a large number of selectable applications simultaneously. However, switching from one application to the next is still a process which requires relatively intense attention by the user, even for the most common applications.

Consequently, there is a need to provide a mobile communication terminal and method providing a user interface with a simpler and more intuitive selection for replying to incoming communications.

Presently, internet and other communication service provider applications (xSP application) are integrated into computing and mobile devices as vertically integrated applications (See e.g. FIG. A). When an xSP application is activated, the application generally commands the resources of the device user interface or display. For example, when an internet service provider application is opened, a user interface or browser specific to that application is enabled. Generally, by entering a unique user name and password, a user can enter and access the features of the application. However, although a single device may be able to store applications and programs for more than one internet service provider, generally only one internet service provider solution can be active at one time on the same device. Thus, if a user was active with a first internet service provider, it would not be possible to communicate with another party using a second, different, internet service provider. Similarly, there may be several service provider applications running simultaneously, but only one of those service provider applications can be active in the foreground of the user interface while the remaining service provider applications are running in the background. If a user wants to use a service provider that is different than the service provider shown in the foreground of the user interface the user has to switch between service provider applications.

### SUMMARY

In one embodiment, a method if provided. The method includes providing a link to at least one selectable communication service for communications to and from a device, wherein the link to the at least one selectable communication service is displayed in at least one area of a display of the device and enabling a user to select a communication service by activating the link associated with the communication service.

In another embodiment, an apparatus is provided. The apparatus includes a display, a controller, a first interface device coupled to the controller and a second interface device coupled to the controller. The controller being configured to provide a user interface for the apparatus on the display. The first interface device being configured to provide a link to at least one communications service provider on the user interface. The second interface device being configured to provide data content to each area of the user interface where a link to a communications service provider is displayed, wherein the data content is received from the communications service provider.

In one embodiment, an apparatus is provided. The apparatus includes means for providing a user interface on a display of a device, means for including a link to at least one communication service provider on the display of the device, means for enabling a communication service provider to maintain a content of an area of the display in which the link is displayed and means for enabling a user to select the link to connect to the at least one communication service while a user interface configuration of the device is maintained.

In another embodiment, a computer program product is provided. The computer program product includes a computer useable medium having computer readable code means embodied therein for causing a computer to provide a link to at least one selectable communication service for communications to and from a device. The computer readable code means in the computer program product includes computer readable code means for causing a computer to provide the link to the at least one selectable communication service for communications to and from the device, wherein the link to the at least one selectable communication service is displayed in at least one area of a display of the device and enabling a user to select a communication service by activating the link associated with the communication service.

In another embodiment, a data structure is provided. The data structure includes at least a first data field including links to at least one function of a communication device and at least a second data field including at least one indicator for each of at least two service providers associated with a respective one of the at least one function.

### BRIEF DESCRIPTION OF THE DRAWINGS

The foregoing aspects and other features of the disclosed embodiments are explained in the following description, taken in connection with the accompanying drawings, wherein:

FIG. 1 illustrates one embodiment of a communications system incorporating features of the invention;

FIG. 2A illustrate one embodiment of an apparatus incorporating features of the invention;

FIG. 2B illustrates another embodiment of an apparatus incorporating features of the invention;

FIG. 3 illustrates one embodiment of a user interface incorporating features of the invention;

FIG. 4A illustrates a block diagram of one embodiment of a system incorporating features of an embodiment;

FIG. 4A illustrates a block diagram of one embodiment of a system incorporating features of an embodiment

FIG. 4B illustrates a block diagram of another embodiment of a system incorporating features of the invention;

FIG. 5 illustrates a block diagram of one embodiment of a system incorporating features of the invention.

FIG. 6 is a schematic diagram of one embodiment of a system incorporating features of the invention.

FIG. 7 illustrates a flow diagram of one embodiment of a process incorporating features of the invention.

FIG. 8 illustrates a block diagram of another embodiment of a system incorporating features of the invention; and

FIG. 9 is a block diagram of one embodiment of a typical apparatus incorporating features of the present invention that may be used to practice the present invention.

### DETAILED DESCRIPTION OF THE EMBODIMENT(S)

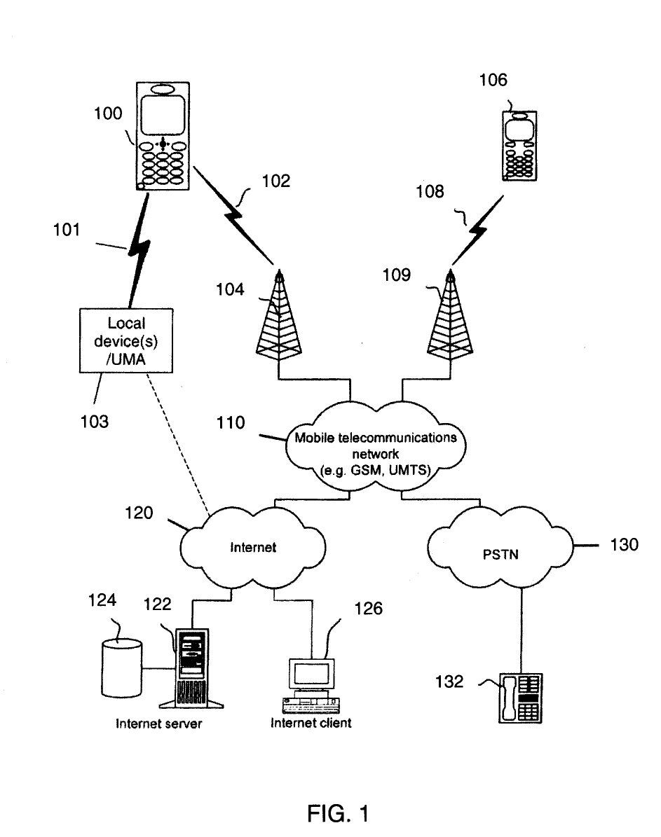

FIG. 1 illustrates a schematic illustration of a communications system, as an example, of an environment in which a communications device 100 incorporating features of an embodiment may be applied. Although aspects of the invention will be described with reference to the embodiments shown in the drawings and described below, it should be understood that these aspects could be embodied in many alternate forms of embodiments. In addition, any suitable size, shape or type of elements or materials could be used.

In the communication system of FIG. 1, various telecommunications services such as cellular voice calls, www/wap browsing, cellular video calls, data calls, facsimile transmissions, music transmissions, still image transmission, video transmissions, electronic message transmissions, electronic commerce and the like may be performed between the mobile terminal 100 and other devices, such as another mobile terminal 106 or a stationary telephone 132, or internet server 122. It is to be noted that for different embodiments of the mobile terminal 100 and in different situations, different ones of the telecommunications services referred to above may or may not be available. The aspects of the invention are not limited to any particular set of services in this respect.

The mobile terminals 100, 106 may be connected to a mobile telecommunications network 110 through radio frequency (RF) links 102, 108 via base stations 104, 109. The mobile telecommunications network 110 may be in compliance with any commercially available mobile telecommunications standard such as GSM, UMTS, D-AMPS, CDMA2000, FDMA and TD-SCDMA.

The mobile telecommunications network 110 may be operatively connected to a wide area network 120, which may be the internet or a part thereof. An internet server 122 has data storage 124 and is connected to the wide area network 120, as is an internet client computer 126. The server 122 may host a www/wap server capable of serving www/wap content to the mobile terminal 100.

For example, a public switched telephone network (PSTN) 130 may be connected to the mobile telecommunications network 110 in a familiar manner. Various telephone terminals, including the stationary telephone 132, may be connected to the PSTN 130.

The mobile terminal 100 is also capable of communicating locally via a local link 101 to one or more local devices 103. The local link 101 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 103 can, for example, be various sensors that can communicate information to the mobile terminal 100 over the local link 101. The local devices 103 may be antennas and supporting equipment forming a WLAN implementing Worldwide Interoperability for Microwave Access (WiMAX. IEEE 802.16). WiFi (IEEE 802.11x) or other communication protocols. The WLAN may be connected to the internet. The mobile terminal 100 may thus have multi-radio capability for connecting wirelessly using mobile communications network 110, WLAN or both. Communication with the mobile telecommunications network 110 may also be implemented using WiFi, WiMax, or any other suitable protocols, and such communication may utilize unlicensed portions of the radio spectrum (e.g. unlicensed mobile access (UMA)). The above examples are not intended to be limiting, and any suitable type of link may be utilized.

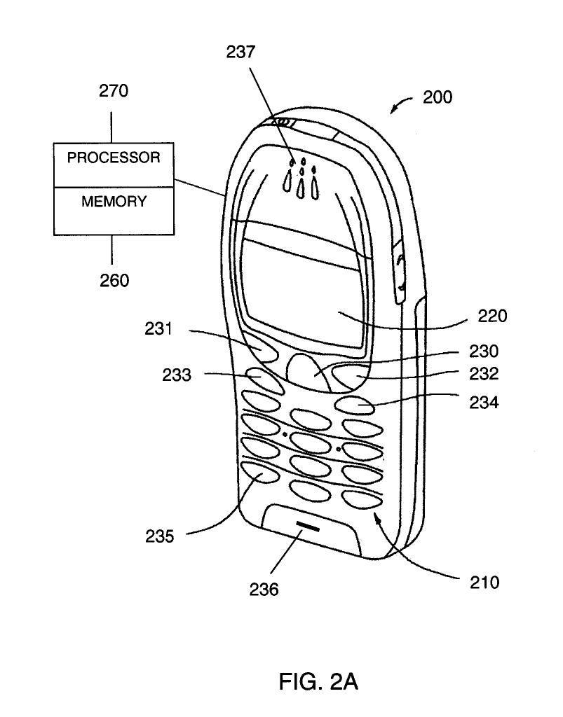

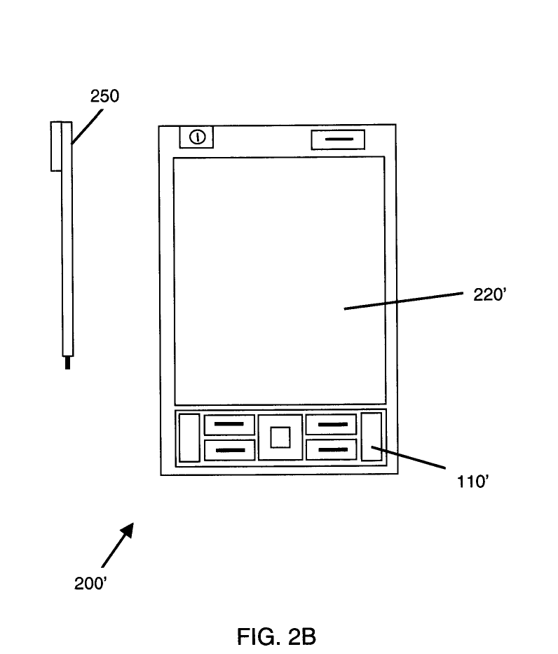

One embodiment 200 of a terminal 100 is illustrated in more detail in FIG. 2A. The mobile communications device or terminal 200 of FIG. 2A may have a keypad 210 and a display 220. The keypad 210 may include any suitable user input devices, such as for example, a multi-function/scroll key 230, soft keys 231, 232, a call key 233 and end call key 234 and alphanumeric keys 235. The display 220 may be any suitable display, such as for example, a touch-screen display or a graphical user interface. The display may be integral to the device 200 or the display may be a peripheral display connected to the device 200. A pointing device, such as for example, a stylus, pen or simply the user's finger may be used with the display 220. In alternate embodiments any suitable pointing device may be used. In other alternate embodiments, the display may be a conventional display. The device 200 may further include a speaker 237 and microphone 236 for use in communications such as, for example telephone conversations, and a processor 270 and memory 260 for implementing aspects of the invention as will be described below. The device 200 may also include other suitable features such as, for example, a camera, loud speaker, connectivity port or tactile feedback features.

In one embodiment, the device 200, may be for example, a PDA style device 200′ illustrated in FIG. 2B. The PDA 200′ may have a keypad 110, a touch screen display 220′ and a pointing device 250 for use on the touch screen display 220′. In still other alternate embodiments, the device may be a personal communicator, a tablet computer, a laptop or desktop computer, a television or television set top box, or any other such device. The embodiments herein will be described with reference to the mobile communications device 200 for exemplary purposes only and it should be understood that the embodiments could be applied equally to any suitable device.

Presently, internet and other communication service provider applications (xSP application) are integrated into computing and mobile devices as vertically integrated applications. When an xSP application is activated, the application generally commands the resources of the device user interface or display. For example, when an internet service provider application is opened, a user interface or browser specific to that application is enabled and displayed. The user interface of the device is typically dominated or controlled by the configuration of the service provider application. Generally, by entering a unique user name and password into the user interface of the service provider application, a user can enter and access the features of the application.

However, although a single device may be able to store applications and programs for more than one internet service provider, generally only one internet service provider solution can be active at one time on the same device. Thus, if a user was active with a first internet service provider, it would not be possible to communicate with another party using a second, different, internet service provider, without closing out one application and switching to and enabling another service provider application, in a different view. Alternatively the user may, put one application in the background of the user interface while switching to another service provider application for use in the foreground of the user interface.

The disclosed embodiments enable multiple internet and other communication service provider applications to be merged or combined into a single view for the user, while still maintaining the unique aspects of each service provider.

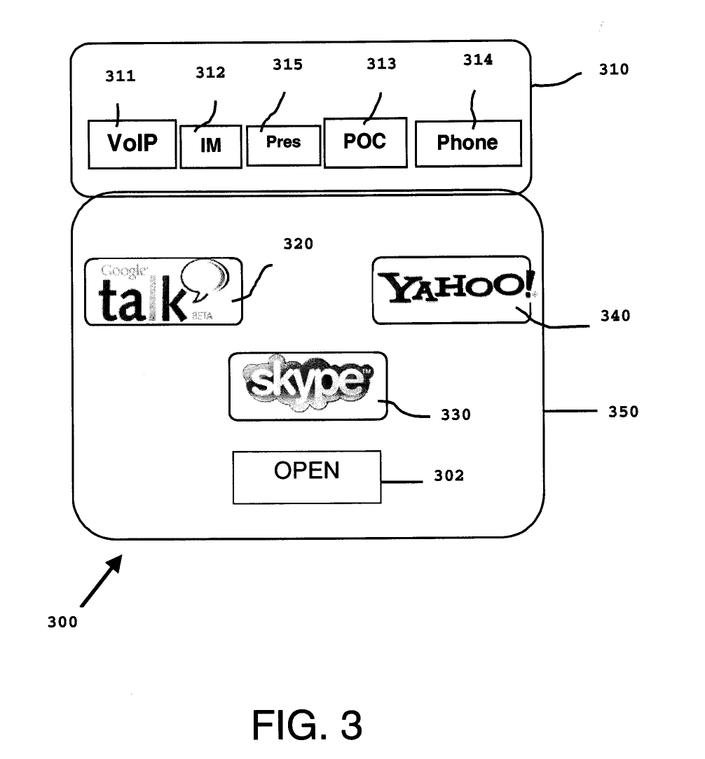

For example, referring to FIG. 3, one embodiment of a user interface 300 incorporating features of the invention is illustrated. The user interface 300, which in one embodiment comprises a user interface for a device such as a terminal 100 of FIG. 1, includes a first region 310 that can be used to display real time communication options, such as for example, voice over internet protocol (VOIP) 311, instant messaging (IM) 312, presence indication 315, push to talk over cellular (POC) 313 and phone 314. It is noted that the phone 314 communication option may be a combined cellular/voice over IP communication option that may be used to initiate and receive, for example, cellular calls such as GSM and the like as well as voice over IP calls from various internet service providers. In alternate embodiments this region 310 can display any suitable or desired functions.

In one embodiment, the regions 311-315 comprise soft keys that are selectable and activatable in any suitable manner. In alternate embodiments, the region 311-315 can comprise any suitable user selectable function key(s) of a device.

The region 350 generally comprises a portion of the user interface 300 of the device that can be used to display links or activation icons to the various communication services that are available to be activated or used with the particular device. Regions 320, 330 and 340 are shown with assigned or designated service providers. The region 302 is available or open for additional features or service providers. Although only these active regions are shown with respect to FIG. 3, in alternate embodiments, any suitable number of function or application areas can be provided. For example, there can be more than just region 302 that is available for the display of additional features. It is a feature of the invention for the user interface 300 to include any suitable number of sections or areas containing any suitable information, menu items or selections available to a user.

In alternate embodiments, the first section 310 may include any suitable information or menu items available to the user. A user may be able to scroll the menu of the first section 310 up, down, left or right using, for example, the multifunction key 130 or a pointing device, to access additional communication channels/protocols.

The first section 310 may also include a presence feature 315 so a user may determine if a party to be communicated with is present on that communication channel/protocol. For example, if a user A is logged into the service Skype™ and wants to communicate with user B, user A can use the presence feature 315 to determine if user B is also logged into the service Skype™. In alternate embodiments, the menu 310 may include any suitable items such as SMS and other protocols.

The menu 310 may include an integrated application engine and a corresponding user interface that may have several internet service providers/protocols running simultaneously. For example, a voice over IP application engine may have YAHOO!® and MSN® (Microsoft Network) voice over IP connections open at the same time. The voice over IP application engine user interface may receive calls through both service providers. For example, where the user is on a call through the MSN® service provider/protocol a call may be received through the YAHOO!® service. The YAHOO!® call may be placed in a mailbox for retrieval by the user at a later time or the user may switch over to the YAHOO!® call from the MSN® call. The user may initiate, for example, a voice over IP call using the voice over IP application engine and its corresponding user interface through, for example, either MSN® or YAHOO!®. Although the application engine was described with respect to voice over IP it is noted that the application engine applies equally to the other communication service providers/protocols described herein (e.g. IM, POC, phone, etc.). It is also noted that the application engine and corresponding user interface may be located in any suitable section of the user interface 300.

The second section 350 of the user interface 300 may display an indication of the different service providers associated with the different communication channels/protocols that are presented in the menu of the first section 310. The user interface 300 may be configured so that as a user scrolls through the menu of the first section 310 a list of different service providers associated with that communication protocol may be presented to the user for selection in the second section 350 of the user interface 300. For example, in FIG. 3 exemplary service providers for voice over IP 311 such as Google Talk™ 320, Skype™ 330 and YAHOO!® 340 that a user may select for communication are shown in section 350. Other examples of service providers that may be displayed when a user selects the instant messenger protocol 312 may include, for example, AOL® (America Online) instant messenger, YAHOO!® instant messenger, ICQ® instant messenger and MSN® (Microsoft Network) instant messenger. Any suitable service providers may be included for a respective one of the menu categories (e.g. 311-315) presented in the first section 310. In this example, the second section 350 of the user interface 300 is configured to display the logo or icon associated with a respective service provider. In alternate embodiments any suitable indicator of the service providers may be utilized.

In this example, the user interface 300 includes a first section 310 and a second section 350 as described above. However, in alternate embodiments, the user interface may include a single section incorporating all of the features of the first and second sections 310, 350. In other alternate embodiments, the features described above with respect to the first and second sections 310, 350 may be divided into more than two sections wherein each of the sections contains any combination of the features described above.

The user interface 300 of FIG. 3 enables having a single user interface that incorporates features and configurations of all associated service providers. It is not necessary to have a single and distinct interface for each service provider. This allows for unifying different protocols/channels and other means for communicating into a single device. The protocols of each of the different service providers are merged into a single user interface that provides that ability to use each different service without the need for a separate user interface for each different service provider.

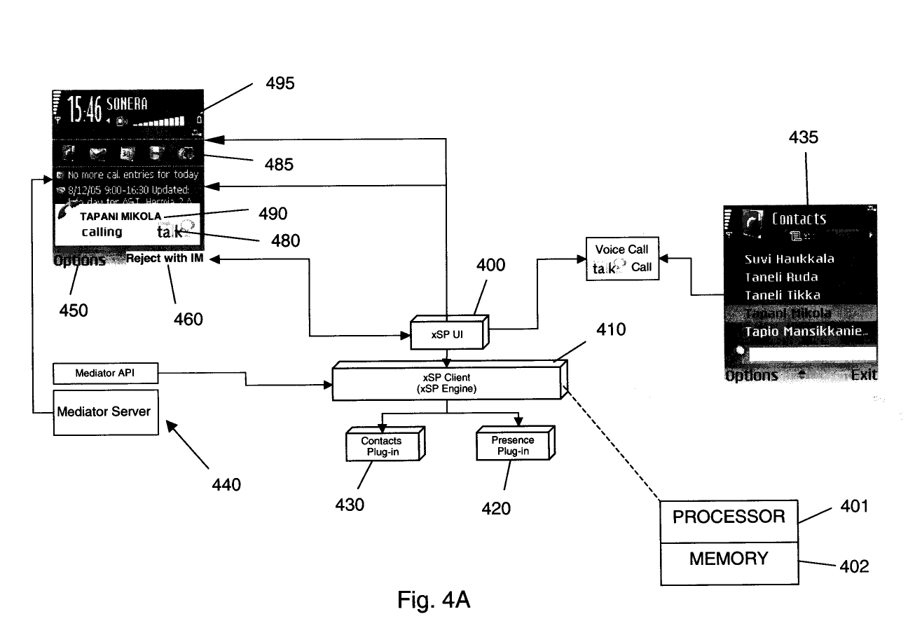

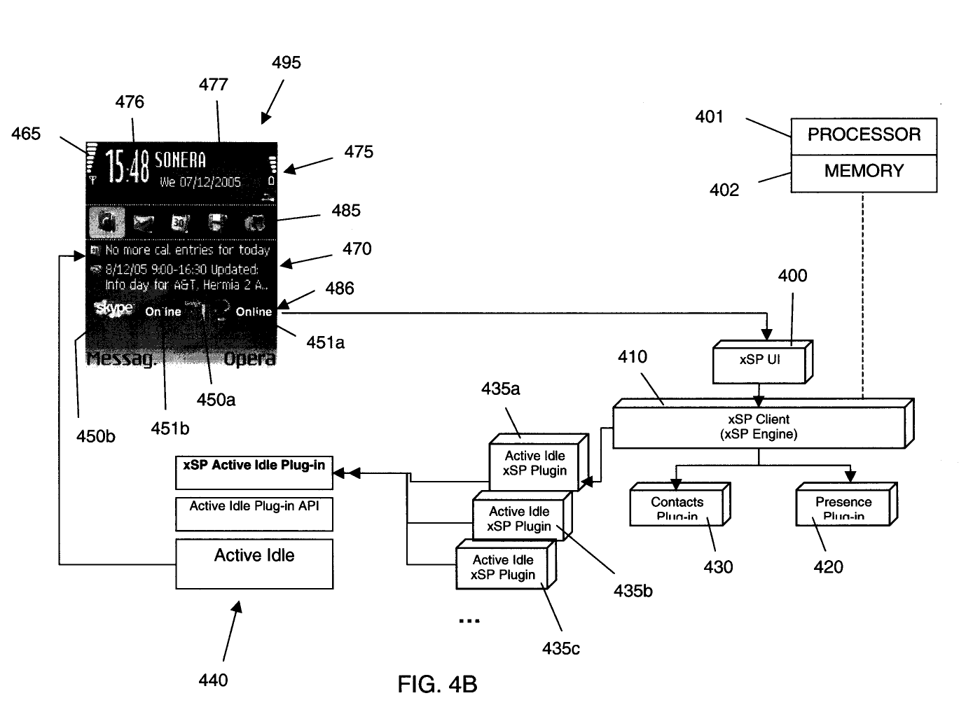

Referring to FIGS. 4A and 4B, in one embodiment, an application programming interface is provided that allows each service provider to interface with the terminal 100 of FIG. 1. The terminal 100 controls the user interface, while the service provider maintains control over its own protocols.

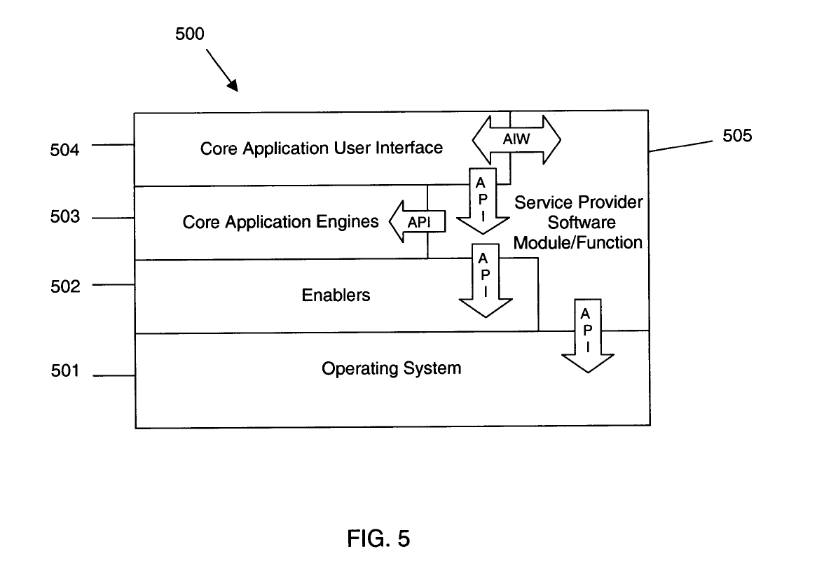

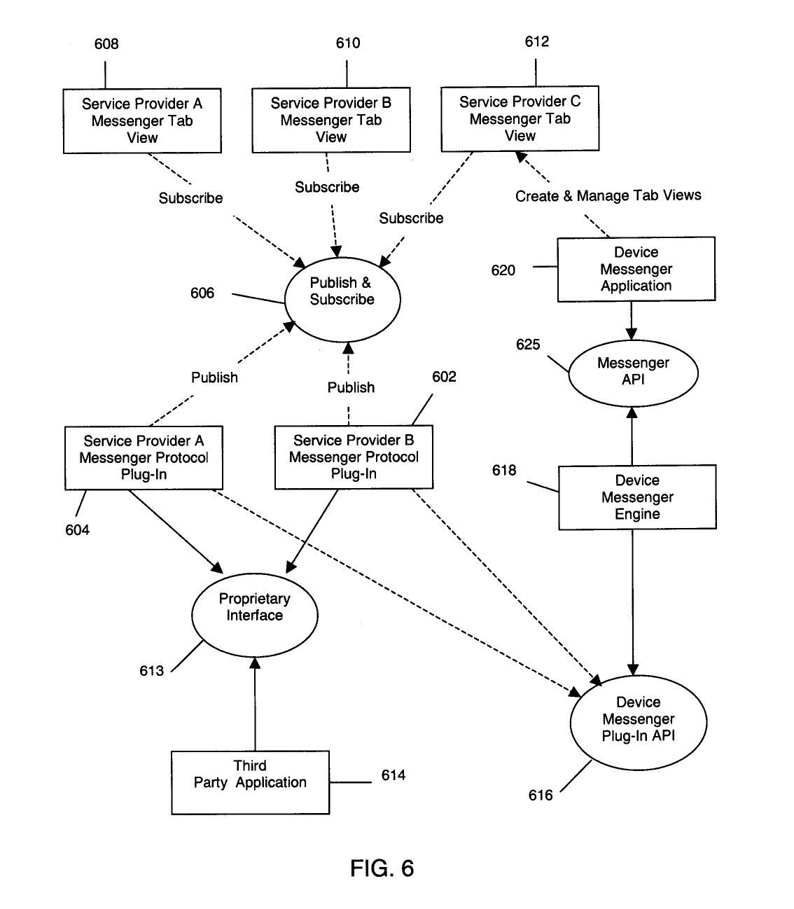

The device 100 may be configured to provide communications over multiple channels or protocols such as, for example, Voice Over IP, instant messaging, cellular phone services, SMS, push to talk over cellular and the like. Referring to FIGS. 4A and 4B, the device may include a service provider user interface 400 and a service provider client engine 410 that may be implemented through the processor 401, and memory 402. In alternate embodiments, the service provider user interface 400 and a service provider client engine 410 may be implemented in any suitable manner. The service provider user interface 400 may provide, via the display 120, a user of the device 100 with the information the user would receive when using a certain communication channel/protocol associated with that service provider. The service provider interface may also be configured to provide application inter-working between an active user interface 495 and inactive applications such as, for example, a contacts list or phone book 435. The service provider client engine 410 may manage the different service providers associated with the device. For example, the service provider client engine 410 may launch a service provider mediator application program interface 440 that identifies the channel/protocol and service provider of an incoming call for display on the device 100. The service provider client may also determine the presence of users on a certain channel/protocol associated with a service provider via a presence plug-in 420 or provide a screen name of a user associated with a service provider via a contacts plug-in 430. The multiple communication channels/protocols associated with the different service providers may be presented to a user of the device 100 through the display as can be seen in FIG. 3. In alternate embodiments, the different communication protocols and service providers may be displayed on or near keys of the keypad of the device and an indication of online or offline status may be provided by, for example, an illumination of an LED and/or key. Referring to FIG. 5, one embodiment of a system 500 incorporating features of the invention is shown. As shown in FIG. 5, an operating system 501 is associated with for example, the terminal 100 of FIG. 1. The operating system may be, for example, Symbian (S90, S80, S60), Linux or any other suitable operating system. Enablers 502 are used to couple the core application engines 503 of the terminal to operating system 501. The enablers 502 may be different communication protocols such as, for example, TCP/IP, XMPP or specific service provider protocols. The core applications engines may correspond to applications such as, for example, calls, messaging, browsing within the terminal 100 or on the internet, searching within the terminal 100 or on the internet and the like. There may be a specific user interface for each of the core applications. In alternate embodiments, any suitable type or number of interface(s) may be utilized for the core applications. Coupled to the core application engines 503 is the user interface 504 associated with the core application of the terminal. It is a feature of the invention to provide an extension of the underlying core application platform for third-party service provider applications. The modules/functions 505 of each of the service providers can be coupled and integrated into the various aspects of the system 500 via application programming interfaces (“API”) (e.g. the API's may provide application inter-working (“AIW”) between the different service provider software modules 505 and the core application user interface 504, engines 503, enablers 502 and operating system 501). The service provider modules/functions 505 may be substantially similar to the service provider plug-ins as shown in FIGS. 4A, 4B and 6. These plug-ins may be launched or accessed at any suitable time so that the service provider functionality is visible through, for example, the core application engines and user interface. In alternate embodiments, any suitable number and types of API's can be used. For example, in one embodiment, a single API can be used to allow the extension and integration of a third party service provider into the user interface of the device 100. Each API allows each communication application, such as 320-340 of FIG. 3 to be resident on the device and activatable from a single user interface of the core system. This configuration and structure allows a single core application to be extended with any number of communication service provider applications. The system 500 and the application user interface 504 may allow a user to access internet search engines such as those search engines provided by the different service providers. The system 500 and the application user interface 504 may also allow a user to access and search internet community web-logs where for example, when there is a change to the content of a web-log related to a certain user, an icon on the user interface may indicate to that user that a change in the web-log has occurred.

Each API shown in FIG. 5, for example, is configured to allow a third-party service provider to integrate the particular service provider application (e.g. third party application) configuration into the underlying core application engine and user interface of the device 100 of FIG. 1. In one embodiment, a user will be able to access each communication application from the user interface of the device, without having to open a specific window and application in order to activate the service provider software module/function 505. Thus, as shown in FIG. 3, a single user interface 300 enables a user to select a particular communication mode or type (311-315) and then select a service provider from the displayed list (302, 320, 330, 340).

For example, user A is using a communication device 100, such as that shown in FIG. 1, that is provided with the system 500 shown in FIG. 5. Using a phone application of the device, user A receives a call from user B over a first communication service application. An example of this is illustrated with respect to FIG. 4A. Both user A and User B are logged into the service application. In one embodiment, user A does not answer the call. The “missed” call can be displayed on the user interface of the device 100. At some late point, user A wants to contact user B, but User A or B is no longer connected to the first service application A. The system 500 will automatically detect a communication application that is common to both User A and User B, and attempt to establish a communication connection using that application. The user A does not have to manually identify a common communication application. An example of such a system is described in co-pending U.S. patent application entitled “REPLYING THROUGH DIFFERENT CHANNELS”, Attorney Docket Number 684-012588-US (PAR) (NC 53191), the disclosure of which is incorporated herein by reference in its entirety.

Referring to FIG. 6, a third party application 614 may be configured with an interface 613 to interact with a corresponding one of the messenger protocol plug-ins 602, 604 for the different service providers. The interface 613 may be substantially similar to the interface shown in FIG. 3. In alternate embodiments, the interface may be any suitable interface. Each messenger protocol plug-in 602, 604 can be described as a publisher. Each messenger protocol plug-in 602, 604 can be associated a specific third-party communications service provider. Each messenger protocol plug-in 602, 604 can maintain a registry of subscribers and sends a notification to each subscriber 608-612 whenever new content becomes available or the publisher changes state. The messenger protocol plug-ins 602, 604 may interface with a device messenger engine 618 through a device messenger plug-in 616. The device messenger engine may store user modifiable settings pertaining to each of the service providers. The device messenger engine 618 may be part of and interface with a device messenger application 620 through interface 625. The device messenger application 620 may be configured to show branded tab views 608, 610, 612 such as, for example, tab views relating to the service providers available to the device 100. In alternate embodiments, the device messenger application 620 may be configured to show any suitable tab views 608, 610, 612 (i.e. branded tabs, generic tabs, or the like). Any suitable number of tab views (e.g. more than one) may be shown by the device messenger application 620. Each of the messenger tab views 608, 610, 612 may be a subscriber that receives the notification from the publisher (e.g. messenger protocol plug-ins 602, 604). The tab views 608, 610, 612 may be connected to the service provider plug-ins as listeners for incoming events/messages based on a publisher-subscriber pattern 606. The subscriber (e.g. the device messenger tab views 608, 610, 612) may retrieve the service providers modified content via the service provider plug-in 602, 604 through a subscription. The service provider plug-ins 602, 604 may render the content of the tab views 608, 610, 612 directly in that the service provider plug-ins 602, 604 may provide a notification when there is something to do (e.g. flashing a tab indicator when there is a new message available).

In one embodiment, referring to FIG. 4A, when an incoming call is received, the user interface 495 may include call identification information such as, for example, a caller designator or name 490 and/or a phone number and the service provider 480 (e.g. service provider brand logo or identification mark) associated with the incoming call. For example, the logo or identifier of the specific service provider may be displayed. In one embodiment, the caller name 490 may be a user name or nickname assigned to the caller by the user of the device 100, as derived from a contacts database 435. One example of such a contacts database 435 is described in co-pending U.S. patent application entitled “UNIFIED CONTACT DATABASE”, Attorney Docket Number 684-012586-US (PAR) the disclosure of which is incorporated herein by reference in it entirety. The service provider user interface 400 may, through application inter-working, obtain the user defined name from the contact list 435. The contact list 435 may be a unified contact list or phonebook that correlates a nickname assigned to the caller by a user of the device 100 with the user names of the caller associated with specific communication service providers or protocols such as MMS, instant messaging and the like (e.g. the caller's user name for a particular service provider such as YAHOO!™ instant messenger). The contact list 435 may allow the device 100 to determine what other channels/protocols are available for communication with the caller. For example, the presence plug-in 420 may use information obtained from the contact list 435 to check or verify the presence of a caller on channels that are associated with that caller in the contact list 435.

The user interface 495 may also include soft key functions such as, for example, an options function 450 and a reply function 460. The options function may be associated with the left soft key 231 of the device 200 of FIG. 2, while the reply function 460 may be associated with the right soft key 232. In alternate embodiments the soft key functions may be associated with any suitable key. The reply function 460 may serve to decline an incoming call and to reply to that call via, for example, an instant message. In alternate embodiments, the reply function 460 may provide a reply via any suitable communication channel/protocol such as, for example, MMS, SMS or email associated with any suitable service provider.

As illustrated in FIGS. 4A and 4B, certain features of the user interface 495 can be unique to a specific service provider. The service provider user interface 400 is linked to the user interface 495 of the device 200. Each service provider controls their own protocols through various plug-ins. Some examples of such plug-ins can include for example, a contacts plug-in 430, a presence plug-in 420, one or more active idle plug-ins 435a-435c. Each plug-in can be operable connected to an application programming interface, such as API 440. In alternate embodiments, any suitable number and types of plug-ins and API's can be utilized to merge the functionality of each service provider into the user interface 495 without the need to fully conform or configure the user interface 495 to a specific service provider application.

In one embodiment, the user interface 495 can include a selection area 485, such as for example a collection of tabs or links, each of which can be enabled and displayed in the user interface 495. The views are defined and window contexts are based on an associated service provider plug-in. For example, the system 500 shown in FIG. 5 may allow each of the different service providers to use their own brand icons in the user interface 495 for their service. A user may activate a particular service by selecting the service provider icon from the user interface 495 of the device. Each underlying service provider application can control aspects of their respective user interfaces provided by the device in the selection area 485 through application interworking via the APIs as shown in FIG. 5. This allows the user to have a single application user interface, with multiple views to various real time communication services.

In one embodiment, the user interface 495 may include a first section 475 that may display, for example, the date 477 and time 476 and signal or service strength/availability 465. The second section 485 may be substantially similar to that described above with respect to FIG. 4A. In addition, the section 485 may allow a user to access any function/application of the device such as for example, email, calendar, phone book, calculator, games, etc. A user may scroll through the function menu 485 with, for example, the scroll key 230 to access additional functions/applications that are available for selection by the user.

The third section 470 may display messages for the user to read. The messages 470 may be any suitable message such as, for example, messages pertaining to received messages or calls (e.g. missed IM, SMS, MMS and/or email messages, cellular or voice over IP calls and the like), a users status pertaining to the communication protocols/service providers (e.g. online or offline status), a buddies status pertaining to the communication protocols/service providers (e.g. the online or offline status of the user's contacts) and calendar entries (e.g. appointments, etc.) such as for example, daily calendar activities, appointment reminders and the like.

The fourth section 486 of the interface 495 may display the user's status 451a, 451b (e.g. online/offline status) pertaining to the communication protocol/service providers 450a, 450b associated with the communication device 200. It is noted that the service providers 450a, 450b shown in FIG. 4 are only examples of the service providers that can be used with the device 200. In alternate embodiments, any suitable service providers may be displayed in section 485 of the idle interface 460.

The idle interface 460 may also include a timer to indicate to the user how long the communication device has remained idle (e.g. the time the user has not used the communications device). It is noted that the arrangement of information shown in the interface 495 is exemplary in nature and the information may be arranged for presentation to the user of the device 200 in any suitable manner.

In one embodiment, the plug-in interfaces illustrated in FIGS. 4A and 4B can be based on a publisher-subscriber pattern, where the view tabs 485 are connected as “listeners” for incoming events and messages. The listeners may allow for the monitoring of surrounding events such as the incoming events, messages and the like. One or more application programming interfaces can be provided to control a plug-in life cycle and define the content that the plug-in will provide to the messenger tabs 485. This allows the integrations of the service provider applications into the core applications (503 of FIG. 5) of the user interface 495.

Each messenger tab 485 of FIG. 4A is considered a subscriber. In one embodiment, a subscriber 608-612 receives a notification from the associated publisher 602, 604 based on a publisher-subscriber pattern. A subscriber 608-612 can retrieve modified content using an interface.

In one embodiment, each plug-in can directly render the content on the tab view 485 of FIG. 4A. The tab view can provide a notification that new information is available. For example, in one embodiment, a particular tab or icon my flash when there is a new message available. In alternate embodiments, any suitable indication can be used to inform a user that new or update information or data is available.

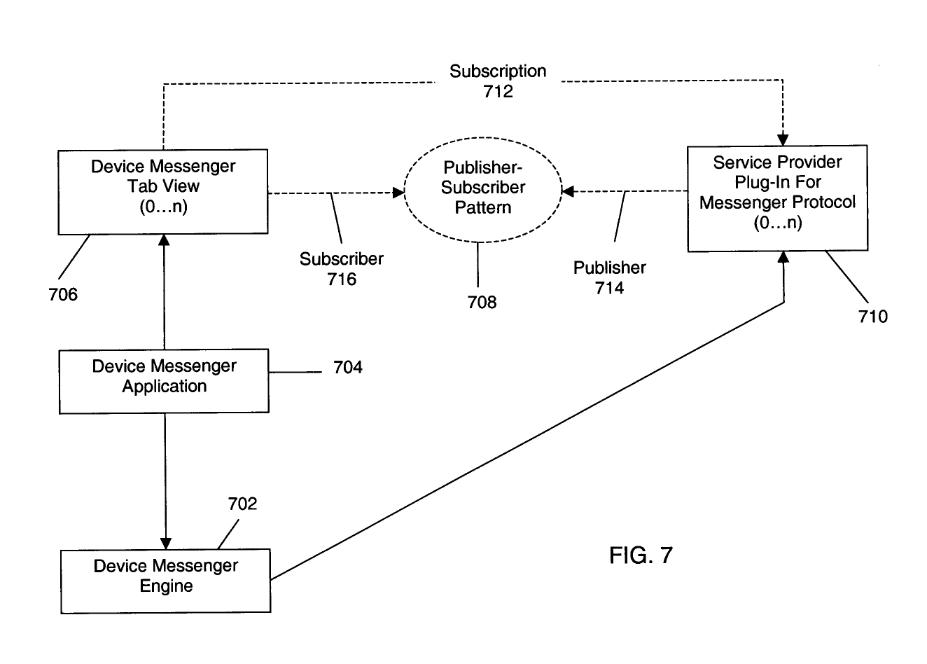

FIG. 7 illustrates one embodiment of a messenger architecture incorporating features of the invention. As shown in FIG. 7, the device messenger application 704 may be configured to show branded tab views 706 such as, for example, tab views relating to the service providers available to the device 100. In alternate embodiments, the device messenger application 704 may be configured to show any suitable tab view (i.e. branded tabs, generic tabs, or the like). Any suitable number of tab views (e.g. more than one) may be shown by the device messenger application 704. The device messenger application 704 may also include a device messenger engine 702. The device messenger engine 702 may store user modifiable settings pertaining to each of the service providers.

The service provider plug in 710 may be part of a public software development kit (“SDK”). Each plug-in 710 may be delivered to the device 100 during manufacture and/or afterwards by, for example, a user or software installer. In alternate embodiments, the plug-ins may be delivered to the device 100 in any suitable manner. Any suitable number of plug-ins may be utilized (e.g. more than one). The service provider plug-ins may maintain a registry of subscribers and send a notification to the subscribers whenever new content is available or the publisher 714 (e.g. service provider) changes state. Each of the messenger tab views 706 may be a subscriber 716 that receives the notification from the publisher 714. The tab views 706 may be connected to the service provider plug-ins as listeners for incoming events/messages based on a publisher-subscriber pattern 708. The subscriber 716 (e.g. the device messenger tab views 706) may retrieve the service providers modified content via the service provider plug-in 710 through the subscription 712. The service provider plug-ins 710 may render the content of the tab views 706 directly in that the service provider plug-ins 710 may provide a notification when there is something to do (e.g. flashing a tab indicator when there is a new message available).

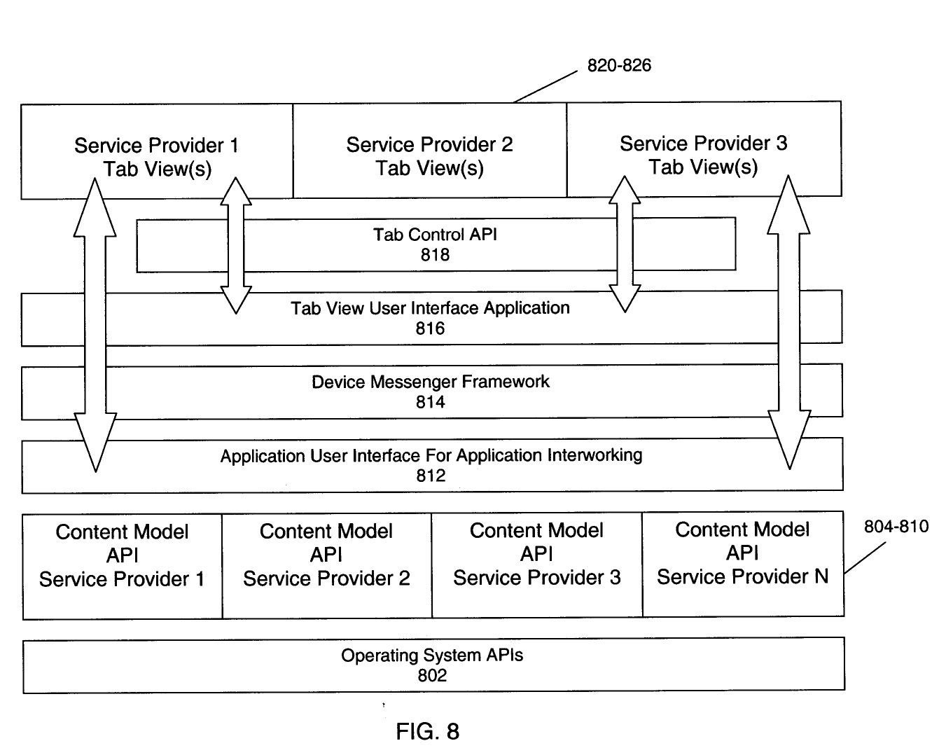

FIG. 8 illustrates one embodiment of a system architecture incorporating features of the invention. As shown in FIG. 8, the service provider tab views 820-826 can contain service provider specific views and links to the underlying applications that are accessible via the respective content model API's 804-810. The plug-in controls 804-810 can directly draw into the respective tab view 820-826 and are the data source of the specific user interface elements.

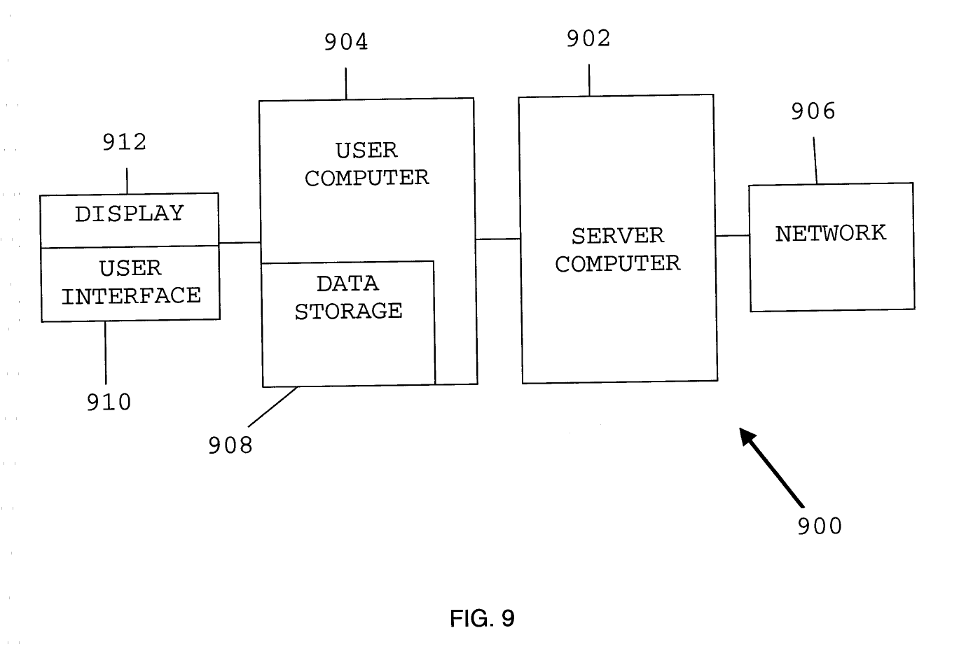

The disclosed embodiments may also include software and computer programs incorporating the process steps and instructions described above that are executed in different computers. FIG. 9 is a block diagram of one embodiment of a typical apparatus 900 incorporating features that may be used to practice aspects of the invention. As shown, a computer system 902 may be linked to another computer system 904, such that the computers 902 and 904 are capable of sending information to each other and receiving information from each other. In one embodiment, computer system 902 could include a server computer adapted to communicate with a network 906. Computer systems 902 and 904 can be linked together in any conventional manner including, for example, a modem, hard wire connection, or fiber optic link. Generally, information can be made available to both computer systems 902 and 904 using a communication protocol typically sent over a communication channel or through a dial-up connection on ISDN line. Computers 902 and 904 are generally adapted to utilize program storage devices embodying machine readable program source code which is adapted to cause the computers 902 and 904 to perform the method steps of the invention. The program storage devices incorporating features of the invention may be devised, made and used as a component of a machine utilizing optics, magnetic properties and/or electronics to perform the procedures and methods of the invention. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 902 and 904 may also include a microprocessor for executing stored programs. Computer 902 may include a data storage device 908 on its program storage device for the storage of information and data. The computer program or software incorporating the processes and method steps incorporating features of the invention may be stored in one or more computers 902 and 904 on an otherwise conventional program storage device. In one embodiment, computers 902 and 904 may include a user interface 910, and a display interface 912 from which features of the invention can be accessed. The user interface 910 and the display interface 912 can be adapted to allow the input of queries and commands to the system, as well as present the results of the commands and queries.

The disclosed embodiments allow a user to combine multiple communication service provider services into a single view for a user, while still maintaining the innovation of the service provider. The applications programming interface allows the user to control the user interface of the device, while all service providers can make use of the same user interface.

It should be understood that the foregoing description is only illustrative of the invention. Various alternatives and modifications can be devised by those skilled in the art without departing from the invention. Accordingly, the disclosed embodiments are intended to embrace all such alternatives, modifications and variances which fall within the scope of the appended claims.

What is claimed is:

1. A method comprising:
providing a link to at least one selectable communication service for communications to and from a device, wherein the link to the at least one selectable communication service is displayed in at least one area of a display of the device; and
enabling a user to select a communication service by activating the link associated with the communication service.

2. The method of claim 1, wherein each area of the display associated with a selectable communication service provides a user interface of the associated communication service.

3. The method of claim 1, further comprising that a configuration of each area of the display associated with a selectable communications service is controlled by a respective communication service.

4. The method of claim 1, further comprising displaying a user interface of a respective communications service provider in each area of the display associated with a selectable communications service.

5. The method of claim 1, wherein activation of an area displaying a link to a selectable communications service allows the user to connect to the service via the device.

6. The method of claim 1, further comprising that each selectable communication service is an Internet real time communication service.

7. The method of claim 1, further comprising displaying the functionality provided by at least one communication protocol in an area of the display, and upon selection of one of the at least one communication protocol, displaying a link to at least one communication service associated with the selected communication protocol in another area of the display.

8. The method of claim 1, wherein a content of each area of the display associated with one the at least one communication service is maintained by a service provider of a communication service associated with the area.

9. The method of claim 9, further comprising publishing content from a service provider application to the display area associated with the service provider.

10. The method of claim 1, further comprising launching an application associated with the at least one communication service provider directly from a user interface of the device.

11. An apparatus comprising:
a display;
a controller, the controller configured to provide a user interface for the apparatus on the display;
a first interface device coupled to the controller, the first interface device configured to provide a link to at least one communications service provider on the user interface; and
a second interface device coupled to the controller, the second interface device configured to provide data content to each area of the user interface where a link to a communications service provider is displayed, wherein the data content is received from the communications service provider.

12. The apparatus of claim 11, wherein the first and second interface device are the same device.

13. The apparatus of claim 11, wherein the second interface device is a plug-in device.

14. The apparatus of claim 11, wherein the first and second interface devices comprise application programming interface devices.

15. The apparatus of claim 11, further comprising an interface device for each feature of a service provided by the communication service provider that is configured to be coupled to the controller and wherein the controller is configured to make the respective service part of the user interface of the device.

16. An apparatus comprising:
means for providing a user interface on a display of a device;
means for including a link to at least one communication service provider on the display of the device;
means for enabling a communication service provider to maintain a content of an area of the display in which the link is displayed; and
means for enabling a user to select the link to connect to the at least one communication service while a user interface configuration of the device is maintained.

17. A computer program product comprising:
a computer useable medium having computer readable code means embodied therein for causing a computer to provide a link to at least one selectable communication service for communications to and from a device, the computer readable code means in the computer program product comprising:
computer readable code means for causing a computer to provide the link to the at least one selectable communication service for communications to and from the device, wherein the link to the at least one selectable communication service is displayed in at least one area of a display of the device and enabling a user to select a communication service by activating the link associated with the communication service.

18. The computer program product of claim 17, further comprising computer readable code means for causing a computer to cause a configuration of each area of the display associated with a selectable communications service to be controlled by a respective communication service.

19. The computer program product of claim 17, further comprising computer readable code means for causing a computer to display a user interface of a respective communications service provider in each area of the display associated with a selectable communications service.

20. The computer program product of claim 17, further comprising computer readable code means for causing a computer to activate an area displaying a link to a selectable communications service, the activation of the area allows the user to connect to the service via the device.

21. The computer program product of claim 17, further comprising computer readable code means for causing a computer to display at least one communication protocol in an area of the display, and upon selection of one of the at least one communication protocol, displaying a link to at least one communication service associated with the selected communication protocol in another area of the display.

22. The computer program product of claim 17, wherein a content of each area of the display associated with one the at least one communication service is maintained by a service provider of a communication service associated with the area.

23. The computer program product of claim 17, further comprising computer readable code means for causing a computer to publish content from a service provider application to the display area associated with the service provider.

24. The computer program product of claim 17, further comprising computer readable code means for causing a computer to launch an application associated with the at least one communication service provider directly from a user interface of the device.

25. A data structure comprising:
at least a first data field including links to at least one function of a communication device; and
at least a second data field including at least one indicator for each of at least two service providers associated with a respective one of the at least one function.

26. The data structure of claim 25, further comprising at least a third data field including messages pertaining to the at least one function.

27. The data structure of claim 25, wherein a status of a user with respect to the at least one service provider is provided with the at least one indicator for each of the at least two service providers.

28. The data structure of claim 25, wherein a respective one of the at least one indicator for the at least two service providers indicates at least a brand of service and a communication protocol for the brand of service.

29. The data structure of claim 25, further comprising at least a fourth data field including an indicator for a service provider associated with an incoming communication.

30. The data structure of claim 25, further comprising at least a fifth data field including an indication of a presence of a contact of the user with respect to the at least one service provider.
